(19) United States
(12) Patent Application Publication
(10) Pub. No.: US 2008/0022590 A1
(43) Pub. Date: Jan. 31, 2008

(54) PICTURE DECORATION HAVING LIVING PLANT

(76) Inventor: Chen-Che CHEN, Chiayi Hsien (TW)

Correspondence Address: HAMRE, SCHUMANN, MUELLER & LARSON, P.C., P.O. BOX 2902, MINNEAPOLIS, MN, 55402-0902, US

(21) Appl. No.: 11/757,058

(22) Filed: Jun. 1, 2007

(30) Foreign Application Priority Data
Jul. 27, 2006 (TW) 095127505

(51) Int. Cl. A01G 9/02

(52) U.S. Cl. 47/72

(57) ABSTRACT

A picture decoration includes a casing having a front open side and configured with an inner accommodating space that has a plant-receiving space portion, a transparent cover mounted sealingly on the front open side of the casing for closing the inner accommodating space in the casing, a decorative member assembled to the casing and having a front side surface formed with a decorative pattern, and a plant unit disposed in the plant-receiving space portion of the inner accommodating space in the casing and including a living plant that has a growing portion extending outwardly of the plant-receiving space portion and disposed between the cover and the decorative member.

### BACKGROUND OF THE INVENTION

1. Field of the Invention

The invention relates to a picture decoration, more particularly to a picture decoration having a living plant.

2. Description of the Related Art

A conventional picture decoration is generally in the form of a watercolor painting, an oil painting, a traditional Chinese painting or a photograph, and merely presents a fixed picture appearance.

### SUMMARY OF THE INVENTION

Therefore, the object of the present invention is to provide a picture decoration that has a living plant.

According to the present invention, a picture decoration comprises:

a casing having a front open side and configured with an inner accommodating space that has a plant-receiving space portion;

a transparent cover mounted sealingly on the front open side of the casing for closing the inner accommodating space in the casing;

a decorative member assembled to the casing and having a front side surface formed with a decorative pattern; and

a plant unit disposed in the plant-receiving space portion of the inner accommodating space in the casing and including a living plant that has a growing portion extending outwardly of the plant-receiving space portion and disposed between the cover and the decorative member.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic front view showing the first preferred embodiment of a picture decoration according to the present invention;

FIG. 2 is a schematic sectional view showing the first preferred embodiment;

FIG. 3 is a schematic front view showing the first preferred embodiment when a growing portion of a plant unit grows up to thereby extend outwardly of a plant-receiving space portion;

FIG. 4 is a schematic sectional view showing the second preferred embodiment of a picture decoration according to the present invention;

FIG. 5 is an exploded perspective view showing the third preferred embodiment of a picture decoration according to the present invention;

FIG. 6 is a schematic sectional view showing the third preferred embodiment;

FIG. 7 is a schematic sectional view showing the fourth preferred embodiment of a picture decoration according to the present invention; and

FIG. 8 is a schematic sectional view showing the fifth preferred embodiment of a picture decoration according to the present invention.

### DETAILED DESCRIPTION OF THE PREFERRED EMBODIMENTS

Before the present invention is described in greater detail, it should be noted that like elements are denoted by the same reference numerals throughout the disclosure.

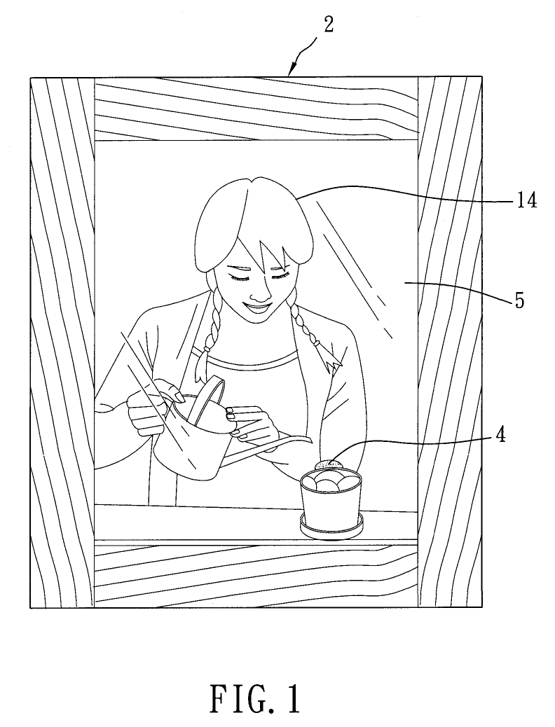

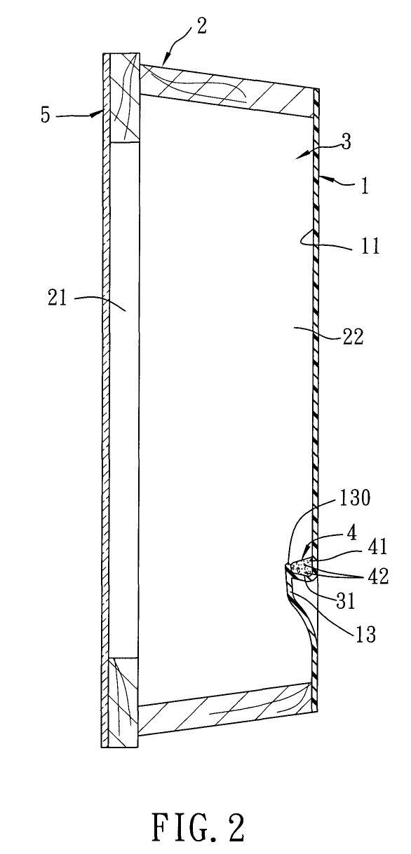

Referring to FIGS. 1 and 2, the first preferred embodiment of a picture decoration according to the present invention is shown to include a rectangular casing 2, a transparent cover 5, a decorative member 1, and a plant unit 4.

The casing 2 has a front open side 21, and is configured with an inner accommodating space 3 that has a plant-receiving space portion 31. In this embodiment, the casing 2 further has a rear open side 22.

The cover 5 is mounted sealingly on the front open side 21 of the casing 2 for closing the inner accommodating space 3 in the casing 2.

The decorative member 1 is assembled to the casing 2, and has a front side surface 11 formed with a decorative pattern 14 that shows a girl holding a container for watering (see FIG. 1). In this embodiment, the decorative member 1 is mounted sealingly on the rear open side 22 of the casing 2, and has a protrusion 13 projecting frontwardly into the inner accommodating space 3 in the casing 2. The protrusion 13 has a top surface 130 formed with a recess that serves as the plant-receiving space portion 31.

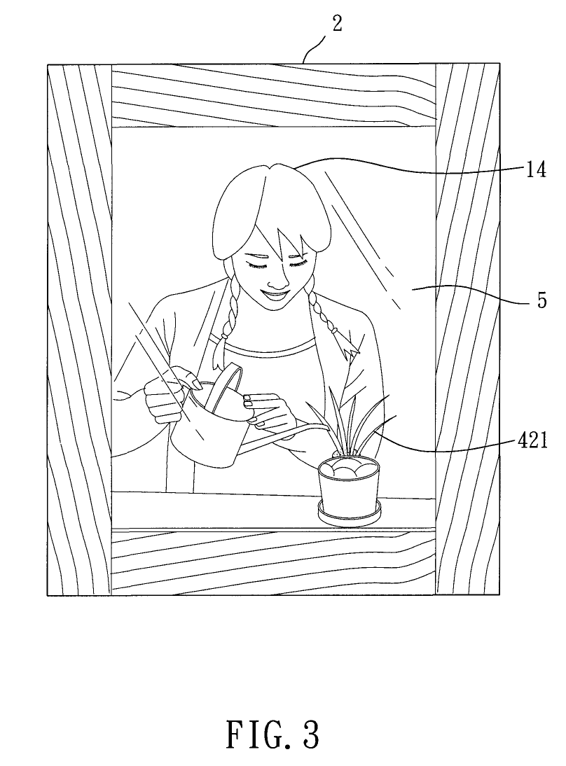

The plant unit 4 is disposed in the plant-receiving space portion 31 of the inner accommodating space 3 in the casing 2, and includes a nutrient supply substance 41 consisting of cotton, wood flours and cultivation liquid, and a living plant 42, such as a plant seed or a seedling, planted onto the nutrient supply substance 41. It is noted that, after a period of time following the planting of the living plant 42, the living plant 42 grows up due to supply of nutrient from the nutrient supply substance 41, light, and air in the inner accommodating space 3 in the casing 2 such that the living plant 42 has a growing portion 421, as shown in FIG. 3. Hence, the growing portion 421 extends outwardly of the plant-receiving space portion 31, and is disposed between the cover 5 and the decorative member 1. As a result, the appearance of the growing portion 421 varies with time, and cooperates with the decorative pattern 14 on the decorative member 1 to compose a variable vivid picture.

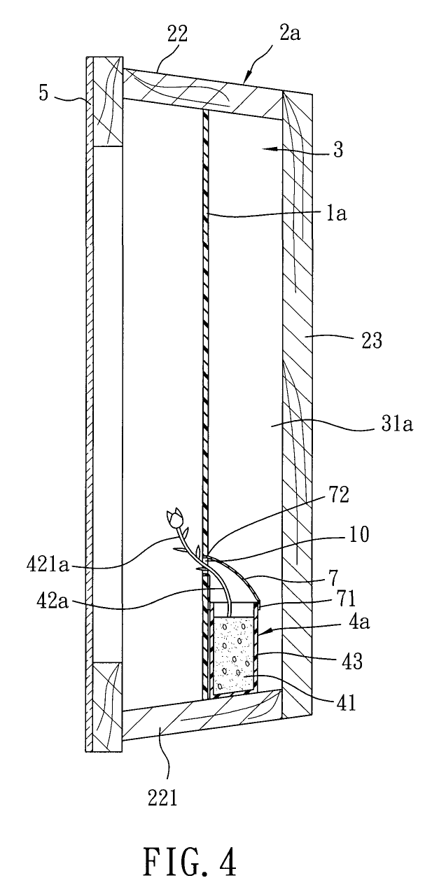

FIG. 4 illustrates the second preferred embodiment of a picture decoration according to this invention, which is a modification of the first preferred embodiment.

In this embodiment, the casing (2a) has a rear wall 23, and a surrounding wall 22 connected fixedly to a periphery of the rear wall 23.

In this embodiment, the decorative member (1a) is disposed in the inner accommodating space 3 in the casing (2a), and is in the form of a flat plate parallel to the rear wall 23 of the casing (2a). It is noted that the plant-receiving space portion (31a) is defined by the decorative member (1a), as well as the rear wall 23 and a part of the surrounding wall 22 of the casing (2a). The decorative member (1a) is formed with a through hole 10.

In this embodiment, the plant unit (4a) is disposed on a bottom wall portion 221 of the surrounding wall 22 of the casing (2a). The plant unit (4a) further includes a container 43 for receiving the nutrient supply substance 41 therein. The through hole 10 in the decorative member (1a) permits extension of the growing portion (421a) of the living plant (42a) therethrough. It is noted that the picture decoration further includes a guiding tube 7 having upper and lower ends 72, 71 connected fixedly and respectively to the decorative member (1a) and the container 43, and in spatial communication with the through hole 10 in the decorative member (1a) such that the growing portion (421a) of the living plant (42a) of the plant unit (4a) is guided by the guiding tube 7 to extend outwardly of the plant-receiving space portion (31a) of the inner accommodating space 3 in the casing (2a) through the through hole 10 in the decorative member (1a). In this embodiment, the lower end 71 of the guiding tube 7 is sleeved fixedly on a top end of the container 43.

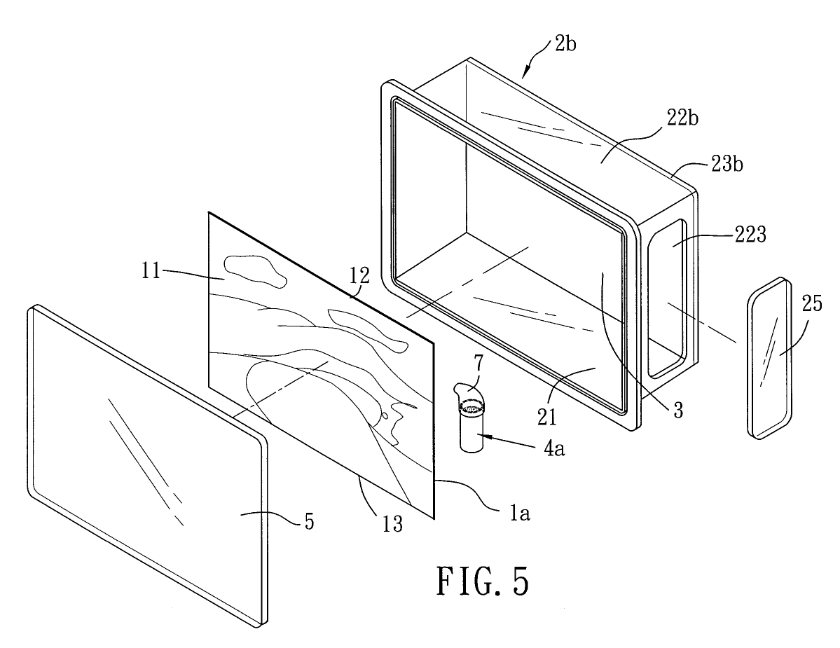

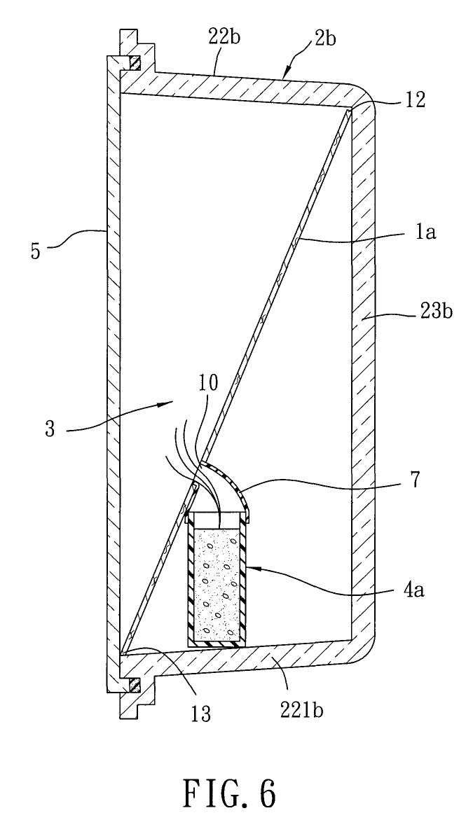

FIGS. 5 and 6 illustrate the third preferred embodiment of a picture decoration according to this invention, which is a modification of the second preferred embodiment.

In this embodiment, the casing (2b) is transparent, and also has the surrounding wall (22b) and the rear wall (23b). It is noted that the surrounding wall (22b) is formed with an opening 223 in spatial communication with the inner accommodating space 3 in the casing (2b). The casing (2b) further has a transparent plate 25 for covering fittingly and detachably the opening 223 in the surrounding wall (22b) of the casing (2b). Due to the presence of the opening 223 in the casing (2b), it is possible to replace the plant unit (4a) and the decorative member (1a).

The decorative member (1a) is inclined, and has an upper end 12 disposed adjacent to the rear wall (23b) of the casing (2b), and a lower end 13 disposed adjacent to the cover 5, as shown in FIG. 6.

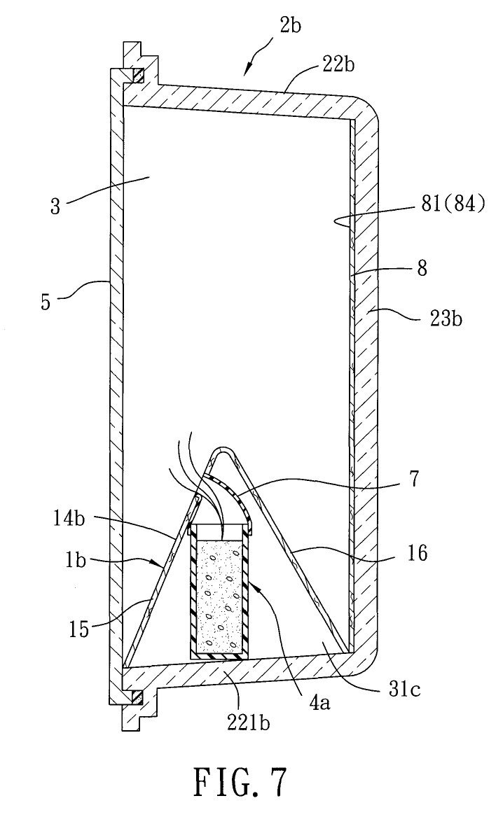

FIG. 7 illustrates the fourth preferred embodiment of a picture decoration according to this invention, which is a modification of the third preferred embodiment.

In this embodiment, the decorative member (1b) is in the form of an inverted V-shaped plate that is disposed on the bottom wall portion (221b) of the surrounding wall (22b) of the casing (2b), and has an inclined first plate portion 15 disposed adjacent to the cover 5 and having a front surface 151 that serves as the front side surface and that is formed with the decorative pattern (14b), and an inclined second plate portion 16 connected to a top end of the first plate portion 15 and disposed adjacent to the rear wall (23b) of the casing (2b). The plant-receiving space portion (31c) is defined by the decorative member (1b) and a part of the surrounding wall (22b) of the casing (2b).

The picture decoration further includes an auxiliary decorative plate 8 disposed in the inner accommodating space 3 and attached to an inner surface of the rear wall (23b) of the casing (2b). The auxiliary decorative plate 8 has a front surface 81 formed with an additional decorative pattern 84 matching the decorative pattern (14b) on the front surface 151 of the first plate portion 15 of the decorative member (1b).

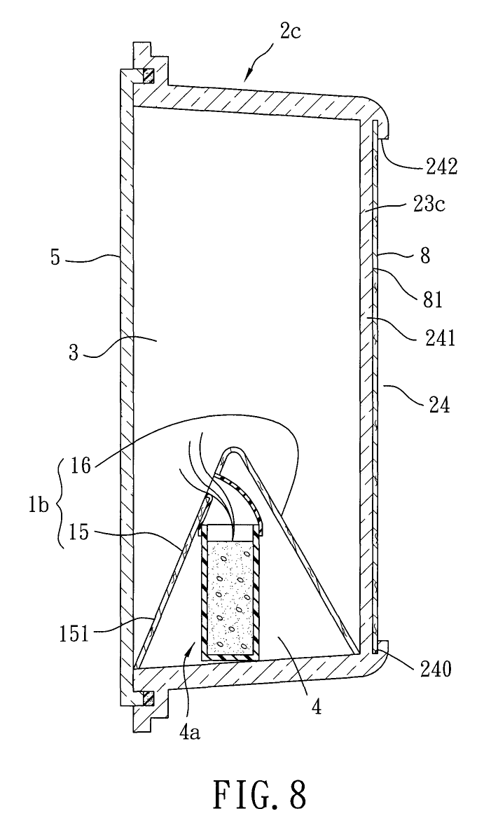

FIG. 8 illustrates the fifth preferred embodiment of a picture decoration according to this invention, which is a modification of the fourth preferred embodiment.

In this embodiment, the rear wall (23c) of the casing (2c) has an outer surface formed with a plate-receiving groove 24 defined by a groove bottom wall 241 and a groove surrounding wall 242. The groove surrounding wall 242 is formed with an annular engaging groove 240. The auxiliary decorative plate 8 is disposed outwardly of the casing (2c), and is mounted in the plate-receiving groove 24. The front surface 81 of the auxiliary decorative plate 8 faces and abuts against the groove bottom wall 241. A periphery of the auxiliary decorative plate 8 engages the engaging groove 240 in the groove surrounding wall 242.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A picture decoration comprising:
a casing having a front open side and configured with an inner accommodating space that has a plant-receiving space portion;
a transparent cover mounted sealingly on said front open side of said casing for closing said inner accommodating space in said casing;
a decorative member assembled to said casing and having a front side surface formed with a decorative pattern; and
a plant unit disposed in said plant-receiving space portion of said inner accommodating space in said casing and including a living plant that has a growing portion extending outwardly of said plant-receiving space portion and disposed between said cover and said decorative member.

2. The picture decoration as claimed in claim 1, wherein:
said casing further has a rear open side; and
said decorative member is mounted sealingly on said rear open side of said casing, and has a protrusion projecting frontwardly into said inner accommodating space in said casing, said protrusion having a top surface formed with a recess that serves as said plant-receiving space portion.

3. The picture decoration as claimed in claim 1, wherein:
said casing has a rear wall, and a surrounding wall connected fixedly to a periphery of said rear wall; and
said decorative member is disposed in said inner accommodating space in said casing, and cooperates with at least one of a part of said surrounding wall and said rear wall of said casing to define said plant-receiving space portion.

4. The picture decoration as claimed in claim 3, wherein said surrounding wall of said casing has a bottom wall portion, said plant unit being disposed on said bottom wall portion of said surrounding wall of said casing.

5. The picture decoration as claimed in claim 3, wherein said decorative member has a through hole for permitting extension of said growing portion of said living plant of said plant unit therethrough.

6. The picture decoration as claimed in claim 5, further comprising a guiding tube interconnecting said decorative member and said plant unit and in spatial communication with said through hole in said decorative member such that said growing portion of said living plant of said plant unit is guided by said guiding tube to extend outwardly of said plant-receiving space portion of said inner accommodating space in said casing through said through hole in said decorative member.

7. The picture decoration as claimed in claim 3, wherein:
said decorative member is in the form of a flat plate; and
said plant-receiving space portion is defined by said decorative member, as well as said rear wall and the part of said surrounding wall of said casing.

8. The picture decoration as claimed in claim 7, wherein said decorative member is parallel to said rear wall of said casing.

9. The picture decoration as claimed in claim 7, wherein said decorative member is inclined, and has an upper end disposed adjacent to said rear wall of said casing, and a lower end disposed adjacent to said cover.

10. The picture decoration as claimed in claim 3, wherein said casing is transparent.

11. The picture decorative as claimed in claim 10, wherein:
said surrounding wall of said casing is formed with an opening in spatial communication with said inner accommodating space in said casing; and
said casing further has a transparent plate for covering fittingly and detachably said opening in said surrounding wall of said casing.

12. The picture decoration as claimed in claim 10, wherein:
said decorative member is in the form of an inverted V-shaped plate disposed on said surrounding wall of said casing, and has an inclined first plate portion disposed adjacent to said cover and having a front surface that serves as said front side surface and that is formed with said decorative pattern, and an inclined second plate portion connected to a top end of said first plate portion and disposed adjacent to said rear wall of said casing; and
said plant-receiving space portion is defined by said decorative member and the part of said surrounding wall of said casing;
said picture decoration further comprising an auxiliary decorative plate assembled to said casing and having a front surface formed with an additional decorative pattern matching said decorative pattern on said front surface of said first plate portion of said decorative member.

13. The picture decoration as claimed in claim 12, wherein said auxiliary decorative plate is disposed in said inner accommodating space in said casing, and is mounted on said rear wall of said casing.

14. The picture decoration as claimed in claim 12, wherein said auxiliary decorative plate is disposed outwardly of said casing, and is mounted on said rear wall of said casing.

15. The picture decoration as claimed in claim 1, wherein said plant unit further includes a nutrient supply substance for supplying nutrient to said living plant.
